(19) United States
(12) Patent Application Publication
(10) Pub. No.: US 2025/0335510 A1
(43) Pub. Date: Oct. 30, 2025

(54) DISTRIBUTED COMPUTING ON COMPUTATIONAL STORAGE DEVICES

(71) Applicant: Gem State Informatics, Inc., Boise, ID (US)

(72) Inventors: Richard Murphy, Boise, ID (US); Allan Porterfield, Durham, NC (US)

(21) Appl. No.: 18/649,429

(22) Filed: Apr. 29, 2024

(51) Int. Cl. G06F 16/903

(52) U.S. Cl. CPC G06F 16/90335

(57) ABSTRACT

A method for querying a large language model (LLM) in a system including a distributed vector database on a plurality of computational storage devices is provided. Each computational storage device of the computational storage devices has a controller and a storage. The method includes modeling a dataset in the storage of each computational storage device to generate vector embeddings, loading the distributed vector database having the vector embeddings on the computational storage devices, generating context vector embeddings for a query, querying the LLM with the query to obtain a query result, and performing a semantic search to retrieve a refined result from the distributed vector database based on the query result and the context vector embeddings.

### STATEMENT REGARDING FEDERALLY SPONSORED RESEARCH OR DEVELOPMENT

This invention was made with government support under DE-SC0021518 awarded by the U.S. Department of Energy. The government has certain rights in the invention.

### FIELD

This disclosure relates generally to systems and methods of distributed computing on computational storage devices. More specifically, the disclosure relates to systems and methods of querying a large language model (LLM) in a system including a distributed vector database on a plurality of computational storage devices; relates to systems and methods of performing a machine learning inference with a distributed LLM on a plurality of computational storage devices; and relates to systems and methods of executing distributed code on a plurality of computational storage devices.

### BACKGROUND

The Large Language Model (LLM) is a deep learning model that is trained on vast amounts of data and can achieve general-purpose language generation and understanding. The LLM can recognize, summarize, translate, predict, and/or generate content using very large datasets. For many corporations and individuals, the LLM is owned and/or operated by a separate business. The owner of the data typically may not want to release the data to the LLM owner and may not want future iterations to be trained using their data because such training may help rival organizations using the same LLM provider. As such, the owner of the data may want to prevent their proprietary information from being exposed to the LLM.

### SUMMARY

Features in the embodiments disclosed herein may eliminate and/or reduce the need for loading the data onto an intermediate processing unit which may model or process each storage element (e.g., a portion of the data) and loading the resulting model into a vector database, and then using contents of the vector database to access the LLM. Features in the embodiments disclosed herein may eliminate and/or reduce the need for requiring powerful standalone processing unit to run or store the vector database, which may be expensive and may consume a large amount of power. Features in the embodiments disclosed herein may further eliminate and/or reduce the need for requiring moving the data to the processing unit and then again to the LLM, which may be energy inefficient.

Features in the embodiments disclosed herein may eliminate and/or reduce the need for bundling a large number of inference requests (to the LLM) into a single block that is handled by processors such as graphics processing units which may apply the LLM on the individual requests in parallel. For example, features in the embodiments disclosed herein may eliminate and/or reduce the need for maintaining the models (e.g., the LLM) on a single compute engine, which requires significant time and energy to repeatedly move active model data onto the compute engine, for artificial intelligence (AI) inference processes.

Features in the embodiments disclosed herein may eliminate and/or reduce the need for each request moving a copy of the data from the storage to the compute engine, which may take time and energy, when processing or accessing a dataset larger than that can be placed in the volatile memory of a processor. For example, for data scientists, features in the embodiments disclosed herein may eliminate and/or reduce the need for each of their requests accessing or examining terabytes of data (which may be different from the data requested by other data scientists but possible overlapping), and such access or process may have significant impact the performance of the computing system.

Features in the embodiments disclosed herein may provide technical solutions to the above technical problems for using or accessing the LLM on a large dataset with data separation. Features in the embodiments disclosed herein may manage AI embeddings (e.g., of a vector database) efficiently, and provide solutions to the challenges especially when the AI embeddings may be large, may exceed the training dataset size, and may need management.

Features in the embodiments disclosed herein may provide a solution to address data separation (e.g., from the LLM), and the solution may be leveraged for other applications. Features in the embodiments disclosed herein may also provide a solution to address the performance of the vector database being limited by bandwidth, particularly for bandwidth communicating with the storage.

Features in the embodiments disclosed herein may provide a decentralized processing resource (e.g., with respect to storage and/or the host computer), to significantly reduce the level of time and energy consumption compared with the existing mechanisms. Features in the embodiments disclosed herein may provide a solution to manage or balance the bandwidth, without reading a large amount of data and then discarding the data and/or without pumping all data into the host computer.

In an example embodiment, a method for querying a large language model (LLM) in a system including a distributed vector database on a plurality of computational storage devices is provided. Each computational storage device of the plurality of computational storage devices has a controller and a storage. The method includes modeling a dataset in the storage of each computational storage device to generate vector embeddings, loading the distributed vector database having the vector embeddings on the computational storage devices, generating context vector embeddings for a query, querying the LLM with the query to obtain a query result, and performing a semantic search to retrieve a refined result from the distributed vector database based on the query result and the context vector embeddings.

In another example embodiment, a method for performing a machine learning inference with a distributed large language model (LLM) on a plurality of computational storage devices is provided. Each computational storage device of the plurality of computational storage devices has a controller and a storage. The method includes loading the distributed LLM on the plurality of computational storage devices. Each computational storage device has a portion of the LLM and contains a dataset. The method further includes distributing a plurality of inference requests to the plurality of computational storage devices, and the controller of each computational storage device executing inference code of the portion of the LLM on the dataset to generate a result based on the inference requests.

In yet another example embodiment, a method for executing distributed code on a plurality of computational storage devices is provided. Each computational storage device of the plurality of computational storage devices has a controller and a storage. The method includes distributing customized code to the plurality of computational storage devices. Each computational storage device has a portion of the customized code and contains a dataset. The method also includes loading the portion of the customized code in the memory of the controller of each computational storage device, and the controller of each computational storage device executing the portion of the customized code on the dataset based on a request to generate a result.

Other features and aspects will become apparent by consideration of the following detailed description and accompanying drawings.

### BRIEF DESCRIPTION OF THE DRAWINGS

References are made to the accompanying drawings that form a part of this disclosure and which illustrate the embodiments in which systems and methods described in this specification can be practiced.

FIG. 1 is a block diagram illustrating the process and data flow for querying an LLM, in accordance with at least some embodiments described herein.

FIG. 2 is a schematic view of an example system for querying an LLM in the system including a distributed vector database on a plurality of computational storage devices, in accordance with at least some embodiments described herein.

FIG. 3 is a schematic view of an example system for performing a machine learning inference with a distributed LLM on a plurality of computational storage devices, and/or for executing distributed code on a plurality of computational storage devices, in accordance with at least some embodiments described herein.

FIG. 4 is a flow chart illustrating an example processing flow for querying an LLM in a system including a distributed vector database on a plurality of computational storage devices, in accordance with at least some embodiments described herein.

FIG. 5 is a flow chart illustrating an example processing flow for performing a machine learning inference with a distributed LLM on a plurality of computational storage devices, in accordance with at least some embodiments described herein.

FIG. 6 is a flow chart illustrating an example processing flow for executing distributed code on a plurality of computational storage devices, in accordance with at least some embodiments described herein.

Like reference numbers represent like parts throughout.

### DETAILED DESCRIPTION

Computational storage drive (CSD) may provide processing capability at the storage interface. It is to be understood that the CSD is described in the U.S. patent application Ser. No. 18/045,298, filed on Oct. 10, 2022, and entitled “HYBRID COMMODITY COMPUTATIONAL STORAGE DEVICES (CSD)”, the entirety of which is incorporated herein by reference. Features in the embodiments disclosed herein may utilize the programming capability of the CSD embedded processors (and/or controllers) to support a distributed vector database across one or more CSD devices.

In the embodiments disclosed herein, each data element may be modeled on the local CSD, e.g., as a vector database. The application or algorithm having the vector database on each CSD may access (e.g., query, etc.) an LMM and interpret the results from the LLM. It is to be understood that the LLM model solutions may be achieved without ever moving the data off the CSD. Features in the embodiments disclosed herein may provide increased throughput to the data (e.g., at or about two times throughput compared with the throughput of a standalone processor solution). Features in the embodiments disclosed herein may also reduce data movement costs since e.g., the vector database is local to the data rather than on a remote (or centralized) processor unit. In the embodiments disclosed herein, initial costs may be reduced since the CSD process (e.g., a microcontroller, etc.) costs much less than high-bandwidth processor instances.

Features in the embodiments disclosed herein may utilize a mechanism (e.g., storage plane for artificial intelligence (SPA)) to simplify large data analysis. Features in the embodiments disclosed herein may load the LLM model onto each storage device (e.g., each CSD) as is the inference code. In the embodiments disclosed herein, a number of requests may be bundled and sent to the storage device containing the data relevant to the requests. The lightweight processor of the CSD may then execute the previously loaded inference code on the corresponding data. The results of the inference process may be returned to satisfy each request. It is to be understood that each processor (of the CSD) may hold a separate portion of the LLM model. Each processor may have its own interface to a portion of the non-volatile storage.

Features in the embodiments disclosed herein may further allow a user (e.g., a data scientist, etc.) to download a customized (or use a previously existing) code or function directly to the storage device (e.g., the CSD) where the data resides. The user may write, receive, or obtain a code or function that may download a portion of the data, and access or process that section (of data) and continue to the next section (of data). When the code or function is complete or executed, the code or function may either return the resultant data to the storage device or pass it to the user for further analysis.

As referenced herein, a “memory” is a term of art and may refer to a device or system that is used to store information for immediate use in a computer or related computer hardware and digital electronic devices. It is to be understood that the phrase “memory” may also refer to “volatile memory”, which is computer memory that requires power to maintain the stored information. Volatile memory includes static random-access memory (SRAM), dynamic random-access memory (DRAM), or the like. SRAM is used for central processing unit (CPU) cache or in small embedded systems requiring little memory. DRAM is used for main memory (also known as internal memory, prime memory, or the like), often referred to simply as memory, which is directly accessible to the CPU. It is to be understood that in most cases, the memory for the memory subsystem can be volatile memory but, in some embodiments, the memory for the memory subsystem can be non-volatile memory.

As referenced herein, a “storage” is a term of art and may refer to a mechanism that enables a computer to retain data. It is to be understood that the phrase “storage” may also refer to non-volatile memory that can retain the stored information even when not powered. Storage devices such as flash drives, hard disks, or the like are a fundamental component of most digital devices since they allow users to preserve all kinds of information such as videos, documents, pictures, and raw data. Data storage may refer to magnetic, optical, mechanical, or other types of media that records and preserves digital information for ongoing or future operations.

As referenced herein, a “host” is a term of art and may refer to processor(s). In an embodiment, a host can be a CPU, which is the electronic circuitry that executes instructions comprising a computer program. It is to be understood that the host can perform out-of-order execution (i.e. dynamic execution) to make use of instruction cycles that would otherwise be wasted. The host can include volatile memory such as CPU cache or the like. In an embodiment, the host can include graphics processing unit(s) (GPUs). It is to be understood that dynamic execution typically cannot cover the latency of local memory access or storage access. Embodiments disclosed herein can give the host only the data that it needs to increase the host's efficiency.

As referenced herein, a “computational storage device” (CSD) is a term of art and may refer to a device that provides computing services in the storage system and supports persistent data storage including NAND flash or any suitable non-volatile memory. It is to be understood that computational storage may refer to architectures that provide computational storage functions coupled to storage, offloading host processing or reducing data movement. It is also to be understood that a CSD may include a processor (e.g., a controller, a microcontroller, a lightweight process) having an internal memory (e.g., a cache, etc.) on the processor, a memory (an external memory) independent or separate from the processor, and a storage. The processor, the memory, and the storage are integrated as a whole to form the CSD.

As referenced herein, a “vector database” is a term of art and may refer to a database or engine that may index, store, and/or provide access to structured or unstructured data (e.g., text or images, etc.) alongside its vector embeddings, which are the data's numerical representation. It is to be understood that the vector database may allow users to find and/or retrieve similar objects quickly at scale in production. It is also to be understood that because of the search capabilities of the vector database, a vector database may refer to a vector search engine. It is further to be understood that a distributed vector database may include a plurality of databases and/or vector databases, e.g., including a vector database on each computational storage device of a plurality of computational storage devices.

As referenced herein, an “embedding” or “vector embedding” is a term of art in artificial intelligence and/or machine learning and may refer to a numerical representation of unstructured data without losing the semantic meaning of the data. It is to be understood that a vector embedding may be a list (vector) of numbers, each describing a feature of the data object. For example, an embedding may be a vector (list) of numbers such as floating-point numbers. The distance between two vectors may measure their relatedness. Small distances between two vectors may suggest high relatedness and large distances may suggest low relatedness. It is to be understood that depending on the used embedding model, the data can be represented in different vector spaces, and it is important to use the same embedding model for all the data to ensure the data are in the respective vector space. It is to be understood that an embedding model may refer to an algorithm (operations, actions, etc.) trained to encapsulate information into dense representations in a multi-dimensional space. The embedding model may be used to enable machine learning models (e.g., an LLM, etc.) to comprehend and reason with high-dimensional data.

As referenced herein, a “semantic search” (or “vector search”, or “similarity search”) is a term of art and may refer to an operation, action, or method of finding and/or retrieving similar objects from the vector database by searching for objects that are close to each other in the vector space.

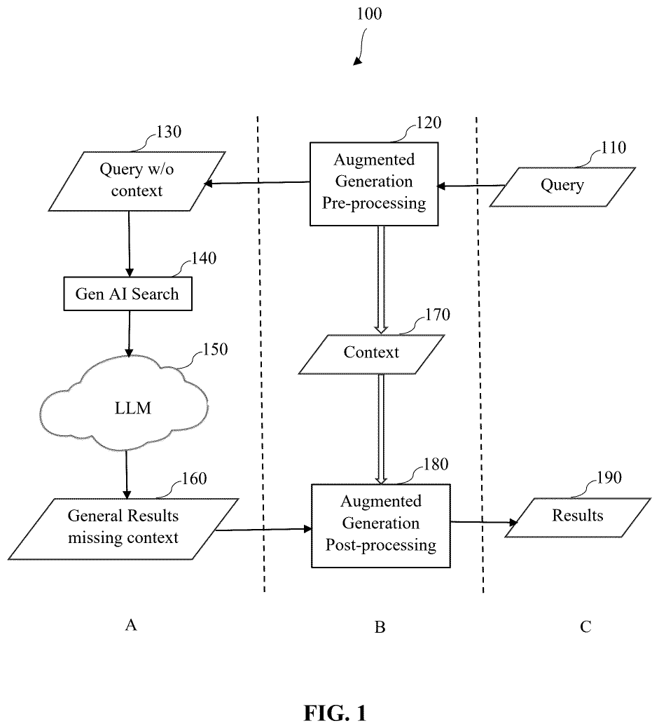

FIG. 1 is a block diagram illustrating the process and data flow 100 for querying an LLM, in accordance with at least some embodiments described herein. The process may start with a query 110 at or from a user side C to an augmented generation pre-processing module 120 at a data owner side B. The process may end with the results 190 to the user side C from an augmented generation post-processing module 180 at or from the data owner side B.

In an example embodiment, the query 110 may be a question, etc. For example, the question may be “How do I turn off the automatic reverse braking on the Car-Model XYZ?” The user may be a data analyst, a data scientist, etc. It is to be understood that the user C and the data owner side B may be the same or different.

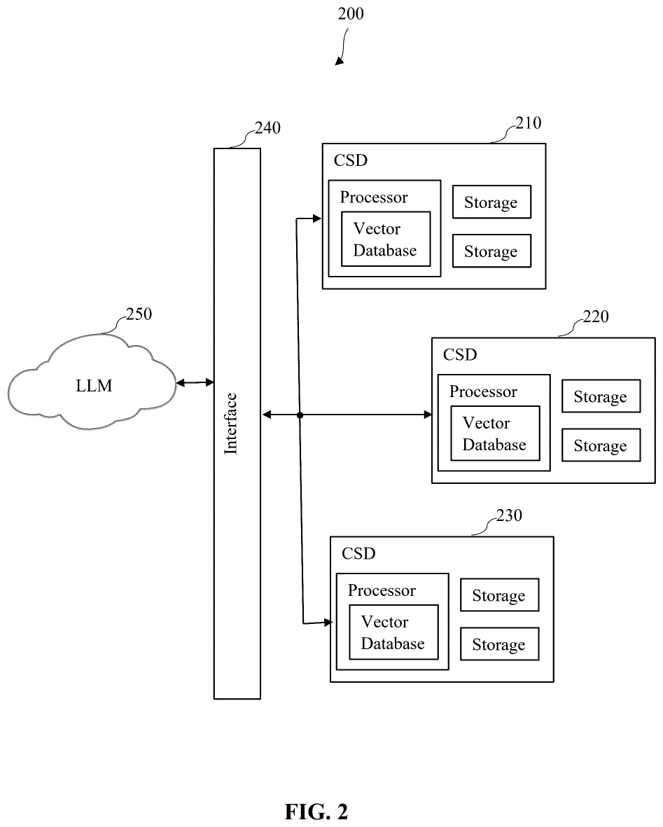

In an example embodiment, the pre-processing module 120 (e.g., a retrieval augmented generation pre-processing) may process the query 110 to (i) generate embeddings (e.g., the context data 170) for the query 110 e.g., using a predetermined or desired embedding model, and/or (ii) to anonymize (and/or dummify) the query 110 to generate a query 130 without the context data of the query 110. That is, the query 110 may be converted to generic unidentifiable string 130. It is to be understood that the process of generating embeddings is to be described in detail in FIG. 2 (e.g., 210, 220, and 230).

In an example embodiment, the query 130 (with the context data of the query 110 being removed) may be sent to the model (e.g., LLM) vendor side A for further processing. For example, the generative AI search module 140 may search the query 130 using a machine learning model 150 (e.g., a trained LLM, etc.) to generate results 160. The results 160 may be general results (missing context data of the query 110) outputted by the model 150 searching the query 130. For example, the general results may be user manual(s) or text from user manual(s) for various car-model(s) that generally answer “How to turn off the automatic reverse braking.”

In an example embodiment, the results 160 from the model vendor side A and the context data 170 from the data owner side B may be sent to a post-processing module 180 (e.g., a retrieval augmented generation post-processing) at the data owner side B.

In an example embodiment, post-processing module 180 may process the results 160 and the context data 170 (e.g., conducting a semantic search on a vector database) to generate the results 190. It is to be understood that the process of conducting a semantic search on a vector database is to be described in detail in FIG. 2 (e.g., 210, 220, and 230).

In an example embodiment, the results 190 may be an answer, etc. For example, the answer may be for the specific Car-Model XYZ and may be “Press the settings button on the center console or the steering wheel. Use the buttons or the touch screen to navigate to the ‘Driver Assistance’ settings. Select the ‘Park Assist’ settings. Look for the option to turn off the automatic reverse braking feature and select it.”

In an example embodiment, the processes 120 and 180 and/or the data 110, 170, and 190 may be performed and/or processed locally in one or more CSDs. The processes 120 and 180 and/or the data 110, 170, and 190 may be invisible to the model 150 such that the data privacy (of data 110, 170, 180) may be protected. The processes 120 and 180 may be performed e.g., by the processor(s) on one or more CSDs. The processes (140, 150) may be performed e.g., by a processor on a host (e.g., in the cloud, etc.). It is to be understood that A (e.g., data, etc.) is “invisible” to B (e.g., machine learning model, etc.) may refer to e.g., A being not exposed to B, A being isolated from B, B having no visibility and/or knowledge of A, etc.

FIG. 2 is a schematic view of an example system 200 for querying a machine learning model 250 in the system including a distributed vector database on a plurality of computational storage devices, in accordance with at least some embodiments described herein.

In an example embodiment, the machine learning model 250 may be an LLM e.g., in the cloud and/or on a host. The interface 240 may be a user or a process that separates the model 250 from the CSDs (210, 220, 230, etc.). Each CSD (210, 220, 230, etc.) may include at least one storage, a processor, and a memory integrated as a whole to form the CSD.

In an example embodiment, the processor on each CSD may e.g., model the dataset(s) on the storage of the CSD, by e.g., processing the dataset(s) to generate vector embeddings for the dataset(s) e.g., using a predetermined or desired embedding model. Each storage of each CSD may have its own or unique dataset(s). The generated vector embeddings may be loaded (e.g., by the processor) into the memory of each CSD and be processed or accessed by the processor of each CSD. It is to be understood that the generated vector embeddings may form a vector database on each CSD, and the vector databases on all the CSDs may form a distributed vector database. It is also to be understood that all the CSDs may use the same embedding model, e.g., to ensure the data are in the same vector space.

In an example embodiment, the processor on each CSD may process a query to generate vector embeddings for the query e.g., using the predetermined or desired embedding model, to achieve the operations of block 120 of FIG. 1, e.g., to return or send the results (e.g., a new query without context) to the model 250 (e.g., for generative AI search, etc.) via the interface 240 and/or a user, and to maintain or keep the vector embeddings (e.g., in the vector database on the CSD) for the query for future use.

In an example embodiment, the processor on each CSD may perform semantic search on the vector database loaded in the memory of each CSD, e.g., based on search results from the model 250 via the interface 240 (and based on the maintained vector embeddings), or based on a request from the interface 240. For example, the processor on each CSD may perform a semantic search to achieve the operations of block 180 of FIG. 1, and to return the results of the semantic search to the interface 240 and/or to a user. The processor on each CSD may receive the generative AI search results from the model 250 via the interface 240, along with the maintained vector embeddings (for the original query), to perform a semantic search on the vector database to obtain the refined results.

In an example embodiment, the interface 240 and/or the user may send request(s) to the processor on each CSD in parallel and combine or integrate the semantic search results from each CSD to form the e.g., refined or final results. Each CSD may perform operations or tasks in parallel or independent to other CSD.

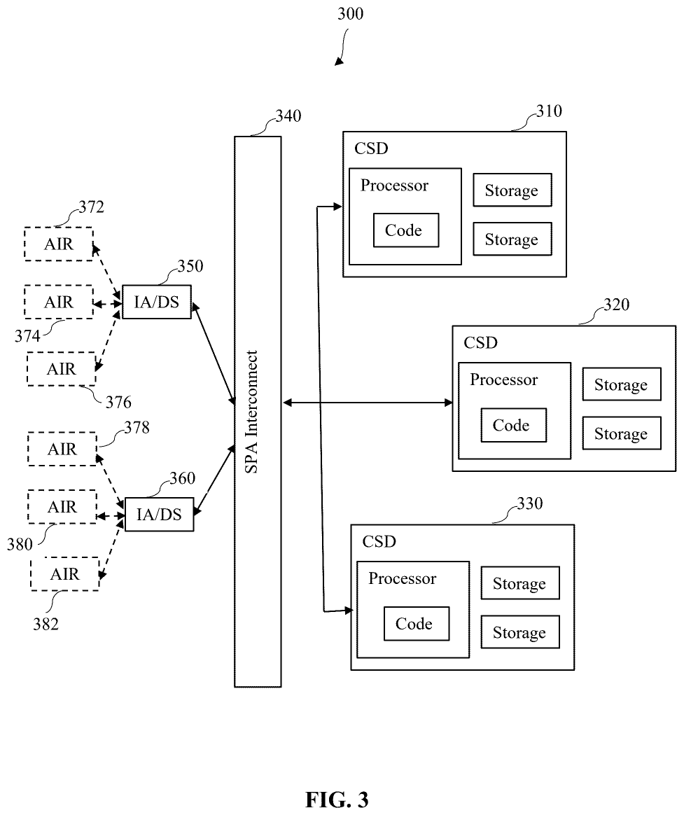

FIG. 3 is a schematic view of an example system 300 for performing a machine learning inference with a distributed LLM on a plurality of computational storage devices, and/or for executing distributed code on a plurality of computational storage devices, in accordance with at least some embodiments described herein.

In an example embodiment, a trained machine learning model (e.g., an LLM, etc.) may be divided and/or separated into portions of e.g., inference code. Each inference code may be distributed to and loaded into a memory of each CSD (310, 320, 330, etc., which may be the same as 210, 220, 230, etc. of FIG. 2, respectively). The system 300 includes one or more inference accumulators (350, 360). Each inference accumulator may be configured to bundle inference requests from applications or computers (372, 374, 376, 378, 380, 382). The bundled inference requests may be sent, e.g., via a mechanism (e.g., storage plane for artificial intelligence (SPA) interconnect 340), to each CSD. The SPA interconnect 340 may be a network, a structure, a wiring, and/or a process that separates the inference accumulators (350, 360) and the CSDs (310, 320, 330, etc.). In an example embodiment, the SPA interconnect 340 may be a container that houses the CSDs (310, 320, 330, etc.). In an example embodiment, the SPA interconnect 340 may be a mechanism to spread the inference requests to all the CSDs.

In an example embodiment, the processor on each CSD may receive the inference requests corresponding to the data on the storage of the CSD, and execute the previously loaded inference code (e.g., a portion of the model) on the corresponding data. In an example embodiment, the inference results may be returned by the processor to the corresponding inference accumulators to satisfy each inference request. It is to be understood that each processor may hold a separate portion of the model. Each processor may also have its own interface to a portion of the non-volatile storage that stores the data. It is also to be understood that each processor may perform the inference code (based on the inference requests) on the data (that correspond to the inference requests and that are stored in the storage) in parallel. In an example embodiment, the SPA interconnect 340 may combine the inference results from each processor of the CSD and return to the corresponding inference accumulators to satisfy each inference request. The corresponding inference accumulators may split or separate the inference results and return the inference results to corresponding applications or computers (372, 374, 376, 378, 380, 382) that send the inference requests.

In an example embodiment, instead of the inference accumulators, 350, 360 may be users such as data scientists who may provide a customized code and load the customized code into a memory of each CSD (310, 320, 330, etc., where the data that correspond to the customized code reside) via the SPA interconnect 340. Each user (350, 360) may provide an executable code that may access/process the loaded customized code to process the data on the storage of each CSD one by one or in parallel, until the executable code is executed completely. The executable code may save the process results to the storage device or pass it back to the data scientist for further analysis.

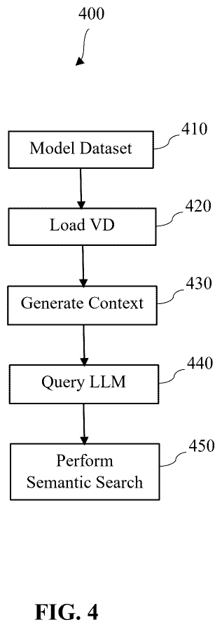

FIG. 4 is a flow chart illustrating an example processing flow 400 for querying an LLM in a system including a distributed vector database on a plurality of computational storage devices, in accordance with at least some embodiments described herein.

It is to be understood that the processing flow 400 disclosed herein can be conducted by one or more processors (e.g., the processor of each CSD, the processor of a host where the machine learning model resides, etc.), unless otherwise specified.

It is also to be understood that the processing flow 400 can include one or more operations, actions, or functions as illustrated by one or more of blocks 410, 420, 430, 440, and 450. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation. It is to be understood that before the processing flow 400, operations including initializations or the like may be performed. For example, system parameters and/or application parameters may be initialized. It is to be understood that the processes, operations, or actions described in FIGS. 1 and 2 may be implemented or performed by the processor. Processing flow 400 may begin at block 410.

At block 410 (Model Dataset), the processor may model the dataset(s) on the storage of each CSD, by e.g., processing the dataset(s) to generate vector embeddings for the dataset(s) e.g., using a predetermined or desired embedding model. Each storage of each CSD may have its own or unique dataset(s). Processing may proceed from block 410 to block 420.

At block 420 (Load VD), the processor may load the generated vector embeddings into the memory of each CSD for further process or access. It is to be understood that the generated vector embeddings may form a vector database on each CSD, and the vector databases on all the CSDs may form a distributed vector database. It is also to be understood that all the CSDs may use the same embedding model, e.g., to ensure the data are in the same vector space. Processing may proceed from block 420 to block 430.

At block 430 (Generate Context), the processor may process a first query to generate embeddings (e.g., the context data) for the first query e.g., using the predetermined or desired embedding model. The processor may also anonymize (and/or dummify) the first query to generate a second query without the context data of the first query. Processing may proceed from block 430 to block 440.

At block 440 (Query LLM), the processor may e.g., invoke a generative AI search module to search the second query using a machine learning model (e.g., a trained LLM, etc.) to generate results. Processing may proceed from block 440 to block 450.

At block 450 (Perform Semantic Search), the processor may perform or conduct a semantic search on a vector database based on, e.g., the generated results from block 440 and the embeddings (e.g., the context data) generated from block 430, to generate refined results.

It is to be understood that features in the embodiments disclosed herein may use generative AI (e.g., on their petabytes of data) and get answers without exposing the data to the machine learning model or the vendor/owner of the model. Features in the embodiments disclosed herein may decrease the data movement, with relatively low power consumption.

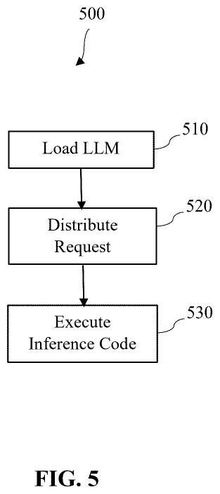

FIG. 5 is a flow chart illustrating an example processing flow 500 for performing a machine learning inference with a distributed LLM on a plurality of computational storage devices, in accordance with at least some embodiments described herein.

It is to be understood that the processing flow 500 disclosed herein can be conducted by one or more processors (e.g., the processor of each CSD, the processor of a host or a computer, etc.), unless otherwise specified.

It is also to be understood that the processing flow 500 can include one or more operations, actions, or functions as illustrated by one or more of blocks 510, 520, and 530. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation. It is to be understood that before the processing flow 500, operations including initializations or the like may be performed. For example, system parameters and/or application parameters may be initialized. It is to be understood that any of the processes, operations, or actions described in FIG. 3 may be implemented or performed by the processor(s). Processing flow 500 may begin at block 510.

At block 510 (Load LLM), the processor (e.g., of each CSD) may load a portion of a trained machine learning model (e.g., an LLM, etc.) into a memory of each CSD. Processing may proceed from block 510 to block 520.

At block 520 (Distribute Request), the processor (e.g., of a host or a computer) may distribute the bundle inference requests from applications or computers to each CSD. Processing may proceed from block 520 to block 530.

At block 530 (Execute Inference Code), the processor (e.g., of each CSD) may execute the loaded portion of the machine learning model (i.e., the inference code), based on the inference requests distributed to the CSD, on the corresponding data in the storage of the CSD, to generate the inference results that satisfy the inference request(s) distributed to the CSD.

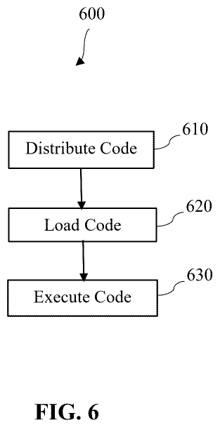

FIG. 6 is a flow chart illustrating an example processing flow 600 for executing distributed code on a plurality of computational storage devices, in accordance with at least some embodiments described herein.

It is to be understood that the processing flow 600 disclosed herein can be conducted by one or more processors (e.g., the processor of each CSD, the processor of a host or a computer, etc.), unless otherwise specified.

It is also to be understood that the processing flow 600 can include one or more operations, actions, or functions as illustrated by one or more of blocks 610, 620, and 630. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation. It is to be understood that before the processing flow 600, operations including initializations or the like may be performed. For example, system parameters and/or application parameters may be initialized. It is to be understood that any of the processes, operations, or actions described in FIG. 3 may be implemented or performed by the processor(s). Processing flow 600 may begin at block 610.

At block 610 (Distribute Code), the processor (e.g., of a host or computer of a user) may distribute a customized code to each CSD via the SPA interconnect. Processing may proceed from block 610 to block 620.

At block 620 (Load Code), the processor (e.g., of each CSD) may load the customized code into a memory of each CSD. Processing may proceed from block 620 to block 630.

At block 630 (Execute Code), the processor (e.g., of each CSD) may execute the loaded customized code by e.g., running an executable code to invoke the customized code (or a portion thereof), to process data on the storage of the CSD, and save or return the results of the process.

It is to be understood that features in the embodiments disclosed herein may reduce data movement since the data are loaded and processed within the CSD. Features in the embodiments disclosed herein may improve the technical field of computation by e.g., minimizing the power consumption (due to less data movement and/or the usage of light weight processor), improving the data and process throughput (e.g., by the CSDs processing in parallel) without exposing the data outside of the CSDs, requiring less memory and/or cache, reducing the cost of computation, distributing or multiplying the functionalities, and/or providing more aggregated bandwidth or memory in the storage. Features in the embodiments disclosed herein may also off-load tasks (e.g., handling or managing token, embeddings, etc.) from the machine learning model (such as the LLM) to the CSDs.

It is to be understood that the disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non-volatile memory, media and memory devices, including by way of example semiconductor memory devices, e.g., erasable programmable read-only memory, electrically erasable programmable read-only memory, and flash memory devices; magnetic disks, e.g., internal hard disks or removable disks; magneto optical disks; and compact disc read-only memory and digital video disc read-only memory disks. The processor and the memory can be supplemented by, or incorporated in, special purpose logic circuitry.

It is to be understood that different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

### ASPECTS

It is appreciated that any of the aspects can be combined with each other.

Aspect 1. A method for querying a large language model (LLM) in a system including a distributed vector database on a plurality of computational storage devices, each computational storage device of the plurality of computational storage devices having a controller and a storage, the method comprising:
modeling a dataset in the storage of each computational storage device to generate vector embeddings;
loading the distributed vector database having the vector embeddings on the computational storage devices;
generating context vector embeddings for a query;
querying the LLM with the query to obtain a query result; and
performing a semantic search to retrieve a refined result from the distributed vector database based on the query result and the context vector embeddings.

Aspect 2. The method of aspect 1, wherein the vector embeddings, the context vector embeddings, and the dataset in the storage of each computational storage device are invisible to the LLM.

Aspect 3. The method of aspect 1 or aspect 2, wherein the modeling of the dataset in the storage of each computational storage device is performed by the controller of each computational storage device.

Aspect 4. The method of any one of aspects 1-3, wherein the distributed vector database includes a database on each computational storage device of the plurality of computational storage devices.

Aspect 5. The method of aspect 4, wherein the performing of the semantic search is performed on the database by the controller of each computational storage device of the plurality of computational storage devices.

Aspect 6. The method of aspect 5, wherein the performing of the semantic search includes coordinating the semantic search on the database by the controller of each computational storage device of the plurality of computational storage devices to retrieve the refined result.

Aspect 7. The method of aspect 5 or aspect 6, wherein the performing of the semantic search includes the computational storage devices performing semantic searches in parallel.

Aspect 8. The method of any one of aspects 1-7, further comprising:
initializing the computational storage devices by loading a polling thread in a memory of the controller of each computational storage device.

Aspect 9. The method of aspect 8, wherein the polling thread is configured to receive instructions for the controller of each computational storage device to execute.

Aspect 10. A method for performing a machine learning inference with a distributed large language model (LLM) on a plurality of computational storage devices, each computational storage device of the plurality of computational storage devices having a controller and a storage, the method comprising:
loading the distributed LLM on the plurality of computational storage devices, each computational storage device having a portion of the LLM and containing a dataset;
distributing a plurality of inference requests to the plurality of computational storage devices; and
the controller of each computational storage device executing inference code of the portion of the LLM on the dataset to generate a result based on the inference requests.

Aspect 11. The method of aspect 10, further comprising:
receiving the plurality of inference requests from a plurality of applications.

Aspect 12. The method of aspect 10 or aspect 11, further comprising:
bundling the plurality of inference requests before distributing the plurality of inference requests.

Aspect 13. The method of any one of aspects 10-12, wherein the loading of the distributed LLM is performed by the controller of each computational storage device.

Aspect 14. The method of any one of aspects 10-13, further comprising:
initializing the computational storage devices by loading a polling thread in a memory of the controller of each computational storage device.

Aspect 15. The method of aspect 14, wherein the polling thread is configured to receive instructions for the controller of each computational storage device to execute.

Aspect 16. A method for executing distributed code on a plurality of computational storage devices, each computational storage device of the plurality of computational storage devices having a controller and a storage, the method comprising:
distributing customized code to the plurality of computational storage devices, each computational storage device having a portion of the customized code and containing a dataset;
loading the portion of the customized code in the memory of the controller of each computational storage device; and
the controller of each computational storage device executing the portion of the customized code on the dataset based on a request to generate a result.

Aspect 17. The method of aspect 16, further comprising:
the computational storage devices performing the request in parallel.

Aspect 18. The method of aspect 16 or aspect 17, wherein the loading of the portion of the customized code is performed by the controller of each computational storage device.

Aspect 19. The method of any one of aspects 16-18, further comprising:
initializing the computational storage devices by loading a polling thread in a memory of the controller of each computational storage device.

Aspect 20. The method of aspect 19, wherein the polling thread is configured to receive instructions for the controller of each computational storage device to execute.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A method for querying a large language model (LLM) in a system including a distributed vector database on a plurality of computational storage devices, each computational storage device of the plurality of computational storage devices having a controller and a storage, the method comprising:
modeling a dataset in the storage of each computational storage device to generate vector embeddings;
loading the distributed vector database having the vector embeddings on the computational storage devices;
generating context vector embeddings for a query;
querying the LLM with the query to obtain a query result; and
performing a semantic search to retrieve a refined result from the distributed vector database based on the query result and the context vector embeddings.

2. The method of claim 1, wherein the vector embeddings, the context vector embeddings, and the dataset in the storage of each computational storage device are invisible to the LLM.

3. The method of claim 1, wherein the modeling of the dataset in the storage of each computational storage device is performed by the controller of each computational storage device.

4. The method of claim 1, wherein the distributed vector database includes a database on each computational storage device of the plurality of computational storage devices.

5. The method of claim 4, wherein the performing of the semantic search is performed on the database by the controller of each computational storage device of the plurality of computational storage devices.

6. The method of claim 5, wherein the performing of the semantic search includes coordinating the semantic search on the database by the controller of each computational storage device of the plurality of computational storage devices to retrieve the refined result.

7. The method of claim 5, wherein the performing of the semantic search includes the computational storage devices performing semantic searches in parallel.

8. The method of claim 1, further comprising:
initializing the computational storage devices by loading a polling thread in a memory of the controller of each computational storage device.

9. The method of claim 8, wherein the polling thread is configured to receive instructions for the controller of each computational storage device to execute.

10. A method for performing a machine learning inference with a distributed large language model (LLM) on a plurality of computational storage devices, each computational storage device of the plurality of computational storage devices having a controller and a storage, the method comprising:
loading the distributed LLM on the plurality of computational storage devices, each computational storage device having a portion of the LLM and containing a dataset;
distributing a plurality of inference requests to the plurality of computational storage devices; and
the controller of each computational storage device executing inference code of the portion of the LLM on the dataset to generate a result based on the inference requests.

11. The method of claim 10, further comprising:
receiving the plurality of inference requests from a plurality of applications.

12. The method of claim 10, further comprising:
bundling the plurality of inference requests before distributing the plurality of inference requests.

13. The method of claim 10, wherein the loading of the distributed LLM is performed by the controller of each computational storage device.

14. The method of claim 10, further comprising:
initializing the computational storage devices by loading a polling thread in a memory of the controller of each computational storage device.

15. The method of claim 14, wherein the polling thread is configured to receive instructions for the controller of each computational storage device to execute.

16. A method for executing distributed code on a plurality of computational storage devices, each computational storage device of the plurality of computational storage devices having a controller and a storage, the method comprising:
distributing customized code to the plurality of computational storage devices, each computational storage device having a portion of the customized code and containing a dataset;
loading the portion of the customized code in the memory of the controller of each computational storage device; and
the controller of each computational storage device executing the portion of the customized code on the dataset based on a request to generate a result.

17. The method of claim 16, further comprising:
the computational storage devices performing the request in parallel.

18. The method of claim 16, wherein the loading of the portion of the customized code is performed by the controller of each computational storage device.

19. The method of claim 16, further comprising:
initializing the computational storage devices by loading a polling thread in a memory of the controller of each computational storage device.

20. The method of claim 19, wherein the polling thread is configured to receive instructions for the controller of each computational storage device to execute.
